(19) United States
(12) Patent Application Publication
(10) Pub. No.: US 2026/0208148 A1
(43) Pub. Date: Jul. 23, 2026

(54) REACTOR FOR DISSOLVING A SOLID FEEDSTOCK BASED ON THERMOSETTING MATERIALS SUCH AS USED-TYRE GRANULES

(71) Applicant: IFP Energies Nouvelles, Rueil-Malmaison (FR)

(72) Inventor: Thierry GAUTHIER, Rueil-Malmaison Cedex (FR)

(73) Assignee: IFP Energies Nouvelles, Rueil-Malmaison (FR)

(21) Appl. No.: 19/140,780

(22) PCT Filed: Dec. 12, 2023
(86) PCT No.: PCT/EP2023/085335

§ 371 Date: Jun. 18, 2025

(30) Foreign Application Priority Data
Dec. 20, 2022 (FR) FR2213914

(51) Int. Cl. B01J 19/24; C08J 11/18

(52) U.S. Cl. CPC B01J 19/2465; B01J 19/2435; C08J 11/18; B01J 2219/1946; B01J 2219/32286; C08J 2321/00

(57) ABSTRACT

Reactor for the dissolution of a solid feedstock existing in the form of aggregates with sizes of, for example, between 1 and 25 mm, such as used tyre aggregates, in the presence of a reaction stream having an upward flow comprising a liquid solvent, said reactor comprising a chamber of elongate shape along the vertical axis, comprising an upper part of cross-section S1 and a lower part of cross-section S2, the cross-section S1 of the upper part being greater than the cross-section S2 of the lower part, said reactor also comprising a loop for recirculation of the reaction stream comprising a means for withdrawal of at least a fraction of the reaction stream located at the level of the upper part and a means for introduction of at least a fraction of the withdrawn reaction stream located at the level of the lower part.

### TECHNICAL FIELD

The present invention relates to the field of the dissolution of solid feedstocks based on thermosetting materials such as used tyre aggregates. It also relates to the field of the dissolution and the conversion of used tyres by thermal decomposition.

### STATE OF THE ART

Processes for the conversion by thermal decomposition of used tyres are generally targeted at producing gas, liquid and solid fractions. The tyre is generally initially ground in order to obtain either ground tyre material still containing a portion of the textile fibres or metal wires contained in the tyre (typically pieces of 1 to 10 cm) or aggregates (generally of less than 6 mm in size) devoid of textile fibres or metal wires. It is possible to react these feedstocks thus prepared by exposing them to heat in order to decompose the used tyre and to recover a gas fraction, a liquid fraction and a solid fraction. To succeed in decomposing the tyre, it is generally necessary to expose the tyre to a quite high temperature, generally of between 300° C. and 900° C., for reaction times ranging from 30 minutes to several hours.

Numerous technologies exist for performing these reactions. It is possible, for example, to submit the tyres to high temperatures in rotary furnaces (Lewandowski et al., Journal of Analytical and Applied Pyrolysis, 140, 2019, 25-53) or in moving beds (EP 2 661 475). These technologies are robust but generally require working at quite high temperatures, generally on average above 500° C. In these processes, the carbon black, generally present in the feedstock in a proportion of 25-40% by weight and originally consisting of very fine sub-micrometric or micrometric particles/agglomerates, tends to agglomerate in the presence of the decomposed rubber which forms a coke binding these structures at various scales, the solid often leaving the reactor in the form of blocks of several millimetres/centimetres which it is then necessary to finely grind in order to reuse this solid as carbon black, which requires a substantial energy expenditure. In these processes, the temperature conditions are high and essentially gas and solid fractions are found in the reactor. The liquids produced then result from the condensation of the gaseous products downstream of the reactor. These high temperature conditions moreover tend to promote polycondensation and coking reactions to form polyaromatic structures via cyclization reactions involving the aromatic and olefinic structures present (M. F. Laresgoiti, B. M. Caballero, I. de Marco, A. Torres, M. A. Cabrero and M. J. Chomón., J. Anal. Appl. Pyrolysis, 71 (2004), 917-934) or coke. The higher the temperature, the greater the contents of polyaromatic structures formed and of coke formed. In point of fact, while aromatic molecules are, first, good solvents and, secondly, find numerous applications, in particular as petrochemical bases, polyaromatic structures are, on the other hand, prejudicial to the quality of the liquid formed and very difficult to refine or to convert. Furthermore, they are coke precursors. There is thus advantage in seeking to minimize polycondensation reactions in order to produce a minimum of polyaromatic structures while preserving the monoaromatic structures present.

In order to improve the quality of the solid phase and to limit the formation of coke on the carbon black, it is possible to lower the partial pressure of hydrocarbons by injecting steam during the cracking reactions which nevertheless require a high temperature above 500° C. to carry out the cracking under essentially gas-solid conditions (US2016/0083657). These gas-solid processes generally lead to productions of gases, noncondensable under the atmospheric conditions, which are very high and of between 10% and 25% by weight, with respect to the tyre feedstock entering the reactor. In point of fact, the upgrading of the reaction gases is locally complex. These gases are thus generally used to produce the heat required to carry out the reactions but this is done to the detriment of the amount of readily upgradable liquid products, which is thus then limited. This is because these liquid fractions are subsequently optionally upgraded to produce new hydrocarbon cuts (naphtha, petrol, kerosene, gas oil, vacuum distillate, residues) used in refineries to produce fuels or in petrochemistry to produce bases subsequently used for the production of plastics. It is nevertheless necessary to refine these cuts in order to bring them to the desired specifications. The more numerous the polyaromatic structures, the more complex the refining.

An alternative route consists in bringing the tyre feedstocks into contact with a liquid, in raising the temperature of this liquid and in dissolving and converting the tyres in a homogeneous liquid phase in which the tyre feedstock is stirred and gradually disappears. An example of this implementation is given in U.S. Pat. Nos. 3,978,199 and 3,704,108. This type of process makes it possible to recover the carbon black in the liquid phase after filtration without there having been agglomeration of these particles or deposition of coke at their surface, as is the case in the reactions operating in the gas-solid phase. Implementation under temperature conditions of less than 450° C. moreover limits the polycondensation reactions of the aromatics, the formation of coke at the surface of the carbon black particles and the formation of gases, which is generally of between 1% and 7% by weight of the incoming feedstock. The use of a solvent containing aromatic fractions, preferentially monoaromatic fractions, is favourable and makes possible better dissolution of the feedstock in the reactor. As tyres are naturally composed of various rubbers, including large amounts of synthetic rubber composed of styrene-butadiene rubbers (SBR), the liquid fractions produced contain major fractions of aromatics and it can be advantageous to separate and to recycle a portion of the liquid formed during the reaction in order to use it as solvent, while the liquid fraction that is not recycled can be sent to a refinery to be refined and then upgraded as a hydrocarbon cut in order to feed the product pools or the petrochemical industry.

More precisely, the process described in U.S. Pat. No. 3,704,108 comprises a fluidized bed reactor fed with a feedstock composed of tyre aggregates, on the one hand, and the solvent, on the other hand. The reaction is carried out in the presence of hydrogen and of catalyst under more severe temperature conditions of between 370° C. and 450° C. No initial stage favouring the dissolution of the tyres is described in this process. On the other hand, it is specified that the formation of a transportable slurry composed of aggregates and of solvents which is transportable and heatable upstream of the reactor requires the use of finely divided tyre particles of between 150 and 3000 μm.

The process described in U.S. Pat. No. 3,978,199 comprises a reactor for contact between the tyres and the solvent making possible the dissolution of the tyres in the solvent and the recovery of the carbon black, this reactor being characterized in that it is perfectly stirred by virtue of mechanical mixing means and that it operates at a temperature of between 260° C. and 370° C. The use of a perfectly stirred reactor requires large amounts of liquid because the rubber tends to become soaked with liquid and to swell. In addition, it is also necessary to fill the intergranular space between the tyre aggregates in order to stir the suspension consisting of the aggregates and the solvent. Thus, the examples illustrate a solvent/tyres degree close to 5 weight/weight. Moreover, the process described consists solely in dissolving the rubber of the tyres at a moderate temperature of less than 370° C., which does not make it possible to efficiently and significantly convert the liquid resulting from the dissolution of the rubber.

The application FR 3 108 617 discloses a process sequence making it possible to convert used tyres and plastics in which a solid feedstock based on ground used tyres existing in the form of aggregates of 5 mm or less is sent into a reaction zone in the presence of a liquid solvent comprising aromatic compounds in order to dissolve, at least in part, said solid feedstock and to thermally decompose, at a temperature of less than or equal to 425° C., said at least partially dissolved solid feedstock in order to obtain carbon black and a first hydrocarbon liquid fraction. The dissolution of the used tyres can be carried out in a first reactor which is mechanically stirred or hydrodynamically stirred by an upward liquid stream. However, the dissolution reactor described does not comprise means for separation of the undissolved aggregates which can be entrained with the liquid at the outlet of the dissolution reactor. This is because, since the reactor is perfectly stirred, a portion of the undissolved aggregates can be entrained in the liquid exiting from the dissolution reactor. In order to minimize this amount of partially or slightly dissolved aggregates at the outlet of the dissolution reactor, it is preferable to use aggregates of relatively small size (<5 mm) in order to have very rapid dissolution of the aggregates which makes it possible to limit the entrainment of aggregates downstream in the liquid products.

A review of the literature shows that the stage of initial dissolution of the used aggregates is important in converting the used tyres into liquid products and recovering the carbon black. The change in tyre shredding and granulating techniques makes it possible today to produce tyre aggregates, the size of which is of the order of 15 to 25 mm, more than 95% devoid of textile or metal fibres. The ability to upgrade large-sized aggregates is advantageous because it makes it possible to reduce the energy and the costs required to produce these aggregates. Nevertheless, the larger the size of the aggregates, the greater the transportation and dissolution problems. An object of the present invention is to provide a reactor for the dissolution, also referred to here as solubilizer, of a solid feedstock based on thermosetting materials, such as used tyre aggregates, making it possible to treat aggregates of any size, thus with current technologies for obtaining aggregates, the size of which can, for example, range up to 25 mm.

### Subject-Matters of the Invention

A first subject-matter according to the invention relates to a reactor for the dissolution of a solid feedstock based on thermosetting materials existing in the form of aggregates with sizes of between a first minimum value and a second maximum value, such as used tyre aggregates, in the presence of a reaction stream having an upward flow comprising a liquid solvent, said solvent being capable of dissolving said solid feedstock, said reactor comprising:
a chamber of elongate shape along the vertical axis, said chamber comprising an upper part of cross-section S1 and a lower part of cross-section S2, the upper part being located above the lower part along the vertical axis;
a means for introduction of the solid feedstock located in the upper part of the chamber;
a means for introduction of the liquid solvent;
a means for discharge of at least a fraction of the reaction stream outside said dissolution reactor;
a means for bleeding off a gas fraction located at the top of the chamber of the reactor; said reactor being characterized in that:
the cross-section S1 of the upper part of the chamber is greater than the cross-section S2 of the lower part of the chamber; and in that
said reactor additionally comprises a loop for recirculation of the reaction stream comprising a means for withdrawal of at least a fraction of the reaction stream located at the level of the upper part of the chamber and a means for introduction of at least a fraction of the withdrawn reaction stream located at the level of the lower part of the chamber.

According to one or more embodiments, the upper part and the lower part have a substantially circular section, and the ratio of the diameter of the cross-section S2 to the diameter of the cross-section S1 is of between 0.1 and 0.8.

According to one or more embodiments, the upper part of the chamber and the lower part of the chamber are connected by a frustoconical element opening out upwards along the vertical axis.

According to one or more embodiments, the half-angle formed by the cross-section of said frustoconical element with the vertical axis is of between 7° and 45°.

According to one or more embodiments, the means for discharge of at least a fraction of the reaction stream is located in the recirculation loop between said withdrawal means and said introduction means.

According to one or more embodiments, said means for introduction of the solid feedstock is located at the top of the chamber of the reactor.

According to one or more embodiments, the means for withdrawal of at least a fraction of the reaction stream is located axially at the centre of the cross-section of the upper part overhung by a deflector.

According to one or more embodiments, the means for introduction of the solid feedstock is located at the periphery of the upper part of the chamber of the reactor.

According to one or more embodiments, the reactor additionally comprises at least one grid positioned along the vertical axis in the upper part of the chamber of the reactor, between the wall of the chamber of the reactor and the means for withdrawal of the reaction stream, and the bottom part of said grid is located at a lower height than the inlet of the withdrawal means.

According to one or more embodiments, the means for introduction of the liquid solvent is located either in the lower part of the chamber or directly in the loop for recirculation of the reaction stream.

Another subject-matter according to the invention relates to a continuous process for the dissolution of a solid feedstock based on thermosetting materials existing in the form of aggregates with sizes of between a first minimum value and a second maximum value in the presence of a reaction stream containing a circulating liquid solvent having an upward flow in a reactor according to the invention, operating at a temperature of between 150° C. and 350° C., said process comprising at least the following stages:
the liquid solvent is introduced into the chamber of the reactor so as to completely immerse the lower part of said chamber and to partially immerse the upper part of said chamber, forming a gaseous headspace above the reaction stream;
the solid feedstock is introduced into the upper part of the chamber of the reactor;
a fraction of the reaction stream located in the upper part of the chamber is withdrawn;
at least a portion of the withdrawn reaction stream is discharged outside said process;
at least a portion of the withdrawn reaction stream is recycled in the lower part of the chamber;
in which the superficial velocity of the reaction stream in the upper part is fixed at a value lower than the terminal fall velocity calculated for aggregates having a size equal to the first minimum value and the superficial velocity of the reaction stream in the lower part is fixed at a value greater than the minimum fluidization velocity calculated for aggregates having a size equal to the first minimum value, it being understood that the superficial velocities in the upper part and the lower part are different.

According to one or more embodiments, the minimum value is equal to 1 mm and the maximum value is equal to 25 mm.

According to one or more embodiments, the superficial velocity of the reaction stream in the upper part (210) is less than 1 cm/s.

According to one or more embodiments, the superficial velocity of the reaction stream in the lower part (220) is of between 2 and 15 cm/s.

According to one or more embodiments, the residence time of the solid feedstock in the lower part of the chamber of the reactor is of between 15 minutes and 20 hours.

According to one or more embodiments, the solid feedstock is introduced into the gaseous headspace located in the upper part of the chamber.

According to one or more embodiments, the ratio by weight of the liquid solvent to the solid feedstock is less than 2.5 weight/weight.

According to one or more embodiments, the solid feedstock is a feedstock based on used tyre aggregates.

### LIST OF THE FIGURES

FIG. 1 is a diagrammatic representation of the reactor according to the invention.

FIG. 2 is a diagrammatic representation of the reactor according to an embodiment according to the invention.

FIG. 3 is a diagrammatic representation of the reactor according to another embodiment according to the invention.

FIG. 4 is a diagrammatic representation of an implementation of the reactor according to the invention in a process for the solvolysis of a feedstock based on used tyres.

### DETAILED DESCRIPTION

### Definitions

In the present description, the term “Cx hydrocarbons” denotes hydrocarbon compounds comprising x carbon atoms. The term “Cx₊ hydrocarbons” denotes hydrocarbon compounds having at least x carbon atoms. The term “Cx to Cy hydrocarbons” denotes hydrocarbon compounds having between x and y carbon atoms.

The terminal fall velocity (Vt) of a particle can be defined according to the following mathematical formula:

$$Vt \underline{=} ( 2. G . Vp . ( \underline{rop} - \underline{rof} ) / ( \underline{Cd . rof . Ap} ) ) \hat{} 0.5$$

with G=9.81 m/s²,
Vp: volume of the particle (m³),
rop: density of the particle in the fluid (kg/m³),
rof: density of the fluid (kg/m³),
Cd: drag coefficient calculated as a function of the Reynolds number (dimensionless),
Ap: sectional surface area projected by the particle in a plane perpendicular to the stream (m²).

The fluidization velocity is a parameter well known to a person skilled in the art and can, for example, be calculated via the correlation indicated in the work by Wen C. H. and Yu Y. H., Chemical Engineering Progress Symposium Series, 82, 100-111 (1966).

The size of the aggregates is defined by their equivalent diameter d_{SV} corresponding to a spherical particle which would have the same surface/volume ratio.

### DETAILED DESCRIPTION

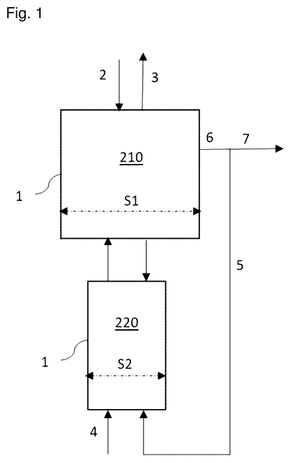

FIG. 1 relates to a reactor for the dissolution of a solid feedstock based on thermosetting materials with sizes, for example, of between 1 and 25 mm, such as used tyre aggregates, in the presence of a reaction stream having an upward flow comprising a liquid solvent, said solvent being capable of dissolving said solid feedstock, said reactor comprising:
a chamber 1 of elongate shape along the vertical axis comprising an upper part 210 of cross-section S1 and a lower part 220 of cross-section S2, the upper part 210 being located above the lower part 220 along the vertical axis, and the cross-section S1 of the upper part 210 of the chamber 1 is greater than the cross-section S2 of the lower part 220 of the chamber 1;
a means for introduction 2 of the solid feedstock located in the upper part 210 of the chamber 1;
a means for introduction 4 of the liquid solvent;
a loop for recirculation of the reaction stream comprising a means for withdrawal 6 of at least a fraction of the reaction stream located at the level of the upper part 210 of the chamber 1 and a means for introduction 5 of at least a fraction of the withdrawn reaction stream located at the level of the bottom 220 of the chamber 1;
a means for discharge 7 of at least a fraction of the reaction stream from said dissolution reactor, preferably located in the recirculation loop between said means for withdrawal 6 of at least a fraction of the reaction stream and said means for introduction 5 of at least a fraction of the withdrawn reaction stream;
a means for bleeding off 3 a gas fraction located at the top of the chamber 1 of the reactor.

According to an essential aspect of the reactor according to the invention, the cross-section S1 of the upper part 210 of the chamber 1 is greater than the cross-section S2 of the lower part 220 of the chamber 1. Preferably, the upper part 210 and the lower part 220 have a substantially circular section, and the ratio of the diameter of the cross-section S2 to the diameter of the cross-section S1 is of between 0.1 and 0.8, preferably of between 0.3 and 0.7. The difference in cross-sectional size between the upper part and the lower part of the chamber of the reactor makes it possible to create, during the operation of the reactor, a difference in superficial velocity of the circulating reaction stream having an upward flow in the chamber of said reactor, depending on whether the reaction stream is found in the upper part or in the lower part of the chamber of the reactor. When the reactor is employed in a process for the dissolution of the solid feedstock, the lower part 220 of the chamber of the reactor, which can be referred to as fluidized bed zone, comprises aggregates of solid feedstock which are undissolved or partially dissolved but with a size of greater than 1 mm which are maintained in the fluidized state by the reaction stream. The upper part 210 of the chamber of the reactor, which can be referred to as disengagement zone or separation zone, comprises aggregates with a size of less than 1 mm resulting from the dissolution of the aggregates, and aggregates with a size of greater than 1 mm which will sediment out and flow towards the lower part of the chamber of the reactor. Thus, due to the structure of the reactor according to the invention, the reaction stream withdrawn via the withdrawal means contains only aggregates of the solid feedstock with a size of less than 1 mm and thus which are easily transportable or pumpable. This dissolution reactor can thus be coupled to a reaction zone making it possible to convert a portion of the withdrawn reaction stream under operating conditions which are more severe than those used during the dissolution of the solid feedstock, making it possible to thermally decompose the aggregates of the solid feedstock with a size of less than 1 mm and to obtain, when the solid feedstock used is based on used tyres, carbon black and a liquid fraction comprising hydrocarbon compounds which can subsequently be upgraded.

The liquid solvent makes it possible to dissolve, at least in part, the solid feedstock. The liquid solvent is preferably a hydrocarbon cut advantageously comprising between 15% and 80% by weight of aromatic compounds, with respect to the total weight of the solvent. Preferably, the liquid solvent comprises less than 10% by weight of hydrocarbon compounds, the boiling point of which is less than 250° C., and less than 10% by weight of hydrocarbon compounds, the boiling point of which is greater than 520° C., with respect to the total weight of the liquid solvent. Preferably, the liquid solvent comprises at least 90% by weight of hydrocarbon compounds, the boiling point of which is between 300° C. and 500° C. The liquid solvent can be composed, wholly or at least in part, of an external solvent. For example, the liquid solvent can result, at least in part, from a heavy distillate cut (HCO or heavy cycle oil).

The liquid solvent can be composed, at least in part, of a fraction of the reaction stream withdrawn in the upper part 210 and recycled in the lower part 220 of the chamber of the reactor via the recirculation loop.

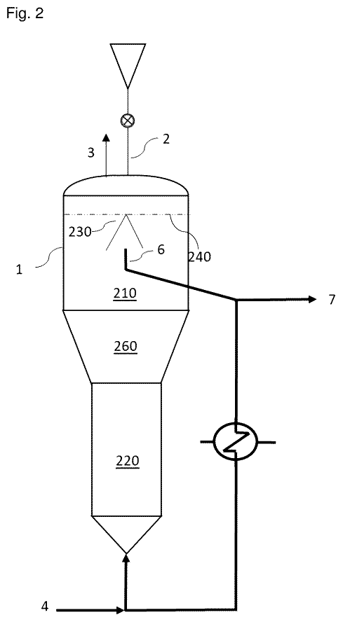

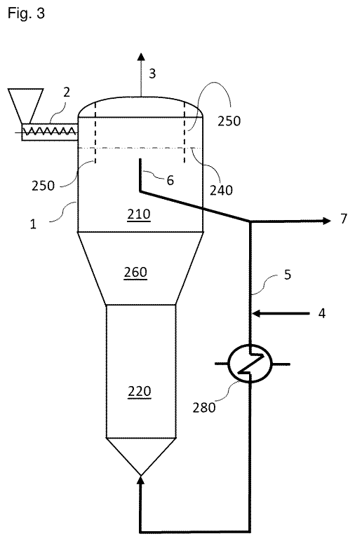

In the embodiment illustrated in FIG. 1, the liquid solvent is supplied via an introduction means 4 located in the lower part 220 of the chamber 1 of the reactor. In the embodiments illustrated in FIGS. 2 and 3, the solvent is supplied to the loop for recirculation of the reaction stream via the introduction means 4. The solvent is injected into the reactor via the means for introduction 5 of at least a fraction of the withdrawn reaction stream. In the embodiment according to FIG. 3, the introduction means 4 is located upstream of a heat exchanger 280 located in the recirculation loop, making it possible to reheat the withdrawn reaction stream and thus also to reheat the liquid solvent supplied before it is introduced into the reactor.

The reactor according to the invention comprises a means for introduction 2 of the solid feedstock located in the upper part 210 of the chamber 1 of the reactor.

In an embodiment according to the invention, as illustrated in FIG. 2, the means for introduction 2 of the solid feedstock is located at the top of the chamber 1 of the reactor. The solid feedstock can thus be fed into the reactor through a system of valves, making it possible to control the flow rate of the solid feedstock entering the reactor. In the embodiment of FIG. 2, the reactor additionally comprises a deflector 230 located above the means for withdrawal 6 of the fraction of the reaction stream, thus making it possible to divert the stream of solid feedstock entering the reactor via the introduction means 2.

In another embodiment according to the invention, as illustrated in FIG. 3, the means for introduction 2 of the solid feedstock is located at the periphery of the upper part 210 of the chamber 1 of the reactor. The solid feedstock is thus fed into the reactor through a screw feed system (screw feeder), making it possible to control the flow rate of the solid feedstock entering the reactor. In this embodiment, the reactor can comprise at least one grid 250, preferably a plurality of grids, positioned along the vertical axis in the upper part 210 of the chamber 1 of the reactor, between the wall of the chamber 1 of the reactor and the means for withdrawal 6 of the reaction stream. Advantageously, the bottom part of said grid 250 is located at a lower height than the inlet of the withdrawal means 6. The grid 250 makes it possible to contain the solid feedstock entering the reactor and to avoid being withdrawn directly by the means for withdrawal 6 of a fraction of the reaction stream.

The loop for recirculation of the reaction stream from the reactor according to the invention comprises the means for withdrawal 6 of a fraction of the reaction stream located at the level of the upper part 210 of the chamber 1 and the means for introduction 5 of at least a fraction of the withdrawn reaction stream located at the level of the lower part 220 of the chamber 1. The withdrawal means 6 makes it possible to withdraw a portion of the reaction stream containing the liquid solvent and a liquid phase resulting from the dissolution of the solid feedstock in the reactor, as well as a fraction of the at least partially dissolved solid feedstock, entrained by the upward flow of the reaction stream. During the use of the reactor in the process for the dissolution of the solid feedstock, the withdrawal means 6 must be positioned in the upper part 210 of the chamber 1 of the reactor and below the gas-liquid interface 240. Preferably, the withdrawal means 6 is located axially at the centre of the cross-section of the upper part 210 of the chamber 1 of the reactor. At least a fraction of the withdrawn reaction stream is recycled in the lower part 220 of the chamber 1 of the reactor via the introduction means 5, which makes it possible to limit the amount of solvent to be introduced into the reactor in order to achieve a reaction stream flow rate making it possible to fluidize the bigger aggregates of the solid feedstock in the lower part 220 of the reactor.

According to an embodiment according to the invention, as illustrated in FIGS. 2 and 3, the upper part 210 of the chamber 1 and the lower part 220 of the chamber 1 are connected by a frustoconical element 260 which opens out upwards along the vertical axis. Preferably, the half-angle formed by the cross-section of said frustoconical element 260 with the vertical axis is of between 7° and 45°, preferably between 10° and 30°.

The reactor according to the invention can thus be employed in a process making possible the dissolution of a solid feedstock based on thermosetting materials, preferably used tyre aggregates, with sizes of between a first minimum value and a second maximum value, for example between 1 and 25 mm, in the presence of a liquid solvent capable of dissolving said solid feedstock. The process is advantageously carried out at a temperature of between 150° C. and 350° C., if it is desired to minimize the conversion of the hydrocarbon compounds present in the reaction stream during the dissolution stage. Preferably, the process is carried out at a temperature of between 200° C. and 320° C. and more preferentially still at a temperature of between 250° C. and 320° C. The process according to the invention comprises at least the following stages:
the liquid solvent is introduced into the chamber 1 of the reactor so as to completely immerse the lower part 220 of said chamber 1 and to partially immerse the upper part 210 of said chamber 1, forming a gaseous headspace surmounting the reaction stream;
the solid feedstock is introduced into the upper part 210 of the chamber 1 of the reactor;
a fraction of the reaction stream located in the upper part 210 of the chamber 1 is withdrawn;
at least a portion of the withdrawn reaction stream is discharged outside said process;
at least a portion of the withdrawn reaction stream is recycled in the lower part 220 of the chamber 1;
in which the superficial velocity of the reaction stream in the upper part 210 is fixed at a value lower than the terminal fall velocity calculated for aggregates having a size equal to the first minimum value and the superficial velocity of the reaction stream in the lower part 220 is fixed at a value greater than the minimum fluidization velocity calculated for aggregates having a size equal to the first minimum value, it being understood that the superficial velocities in the upper part and the lower part are different.

As described above, the difference in cross-sectional size between the upper part and the lower part of the chamber of the reactor makes it possible to create, during the operation of the reactor, a difference in superficial velocity of the circulating reaction stream having an upward flow in the chamber of said reactor, depending on whether the reaction stream is found in the upper part or in the lower part of the chamber of the reactor.

The superficial velocity of the reaction stream in the lower part 220 must be greater than the minimum fluidization velocity of the biggest used tyre aggregates included in said reaction stream. The minimum fluidization velocity is a characteristic which is well known to a person skilled in the art and which depends on the size of the aggregates, on the density of the aggregates in the reaction stream, on the density of the liquid and on the viscosity of the liquid contained in the reaction stream. By way of example, for tyre aggregates with a diameter of 20 mm, the minimum fluidization velocity generally varies between 1 and 15 cm/s, preferentially between 3 and 10 cm/s. If the size of the aggregates decreases, the minimum fluidization velocity decreases; it is thus necessary for the velocity of the reaction stream in the lower part of the chamber of the reactor to be greater than the minimum fluidization velocity of the biggest aggregates in order to ensure that the aggregates are well mixed under the effect of the fluidization. Consequently, the superficial velocity of the reaction stream located in the lower part 220 is of advantageously between 2 and 15 cm/s and more preferentially between 5 and 10 cm/s.

The superficial velocity of the reaction stream in the upper part 210 must be less than the terminal fall velocity of the biggest aggregates, which can thus be entrained in the reaction stream. The terminal fall velocity characterizes the minimum velocity to which an aggregate can be subjected in order to entrain it in a vertical flow. This characteristic is well known to a person skilled in the art and depends on the size of the aggregates, on the density of the aggregates in the liquid stream, on the density of the liquid and on the viscosity of the liquid contained in the reaction stream. By way of example, for tyre aggregates of 1 mm, the terminal fall velocity in the reaction stream is generally greater than 1 cm/s. In order to avoid the entrainment of particles with a size of greater than 1 mm, the upper part 210 is advantageously given dimensions so that the superficial velocity of the reaction stream in the upper part is less than 1 cm/s, preferentially less than 0.5 cm/s.

Preferably, the solid feedstock is introduced into the gaseous headspace located in the upper part 210 of the chamber 1 of the reactor. Thus, the solid feedstock flows by gravity into the gas phase before entering the liquid phase comprising the reaction stream. Advantageously, an inert gas can be introduced into the chamber of the reactor with the solid feedstock in order to avoid any heating by convection of the solid feedstock supplied via the introduction means 2 and which furthermore makes it possible to facilitate the passage of the solid feedstock in said introduction means. A bleed means 3 located at the top of the chamber of the reactor makes possible the discharge of an appropriate amount of gas fraction.

During the implementation of the process according to the invention, a fraction of the reaction stream located in the upper part 210 of the chamber 1 is withdrawn. The withdrawal is carried out via a withdrawal means 6 which makes possible the exit of at least a fraction of the reaction stream containing the liquid solvent, the liquid resulting from the dissolution of the solid feedstock, as well as a portion of the solid feedstock, the size of which is preferably less than 1 mm. At least a portion of the withdrawn reaction stream is discharged from the process via a discharge means 7 located in the recirculation loop, the other part of the reaction stream being recycled in the lower part 220 of the chamber 1 of the reactor via the introduction means 5. Advantageously, the withdrawn reaction stream is heated via a heat exchanger 280 before being reintroduced into the chamber of the reactor. Advantageously, an extra contribution of liquid solvent can be introduced into the circulation loop via the introduction means 4 in order to be mixed with the withdrawn reaction stream before being sent into the chamber of the reactor (cf. FIGS. 2 and 3). Preferably, the means for introduction 4 of the liquid solvent is located upstream of the heat exchanger 280.

Preferably, the residence time of the solid feedstock in the lower part 220 of the chamber of the reactor is of between 15 minutes and 20 hours, preferably between 15 minutes and 3 hours, in order to make possible the dissolution of the aggregates of the solid feedstock.

Preferably, the fraction by volume occupied by the solid feedstock in the lower part 220 of the chamber 1 of the reactor is of between 10% and 50% by volume, preferably between 15% and 30% by volume, so as to be sufficiently low to avoid any risk of clogging of the reactor by accumulation of the aggregates of the solid feedstock.

It is possible to adjust the void ratio by modifying the superficial velocity of the liquid in the section S2 of the lower part 220 of the chamber 1.

Resorting to a portion of the recycled reaction stream as liquid solvent makes it possible to make use of a very limited amount of external solvent. This is because the minimum amount of solvent necessary to operate a dissolution system without recycling of the reaction stream, relative to the amount of aggregates of solid feedstock to be dissolved, is greater than 3 weight/weight, indeed even between 4 and 5 weight/weight, in order to be able to dissolve the solid feedstock without risk of blocking or clogging of the reactor. In the context of the process according to the present invention, the ratio by weight of the liquid solvent to the solid feedstock is less than 2.5 weight/weight, preferably less than 2 weight/weight.

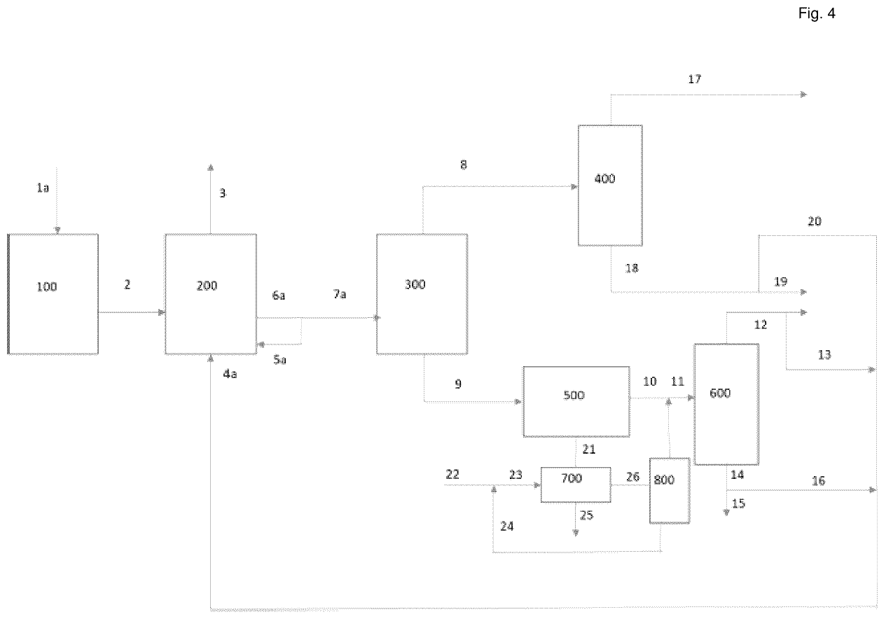

FIG. 4 illustrates a possible implementation of the reactor according to the invention in a process for the solvolysis of a solid feedstock provided in the form of used tyre aggregates. The aggregates to be recycled 1a are stored in a silo 100 before being introduced into the dissolution reactor according to the invention 200 via the introduction means 2, in which they are brought into contact with a hydrocarbon cut via the line 4a as liquid solvent which is produced here in situ by virtue of the separation of the products of the solvolysis process. Depending on the operating pressure of the dissolution reactor, it is possible to have available other silos upstream of the silo 100 between which the aggregates to be recycled circulate in a cycle, which makes it possible to ensure the pressurization of the last silo feeding the reactor. The dissolution stage is carried out at a temperature of between 150° C. and 350° C. in order to minimize the conversion of the liquid hydrocarbon fractions present and the pressure is adjusted in order to minimize the vaporization of the hydrocarbons. It is also possible to use, at least partially, an external solvent as was described above. A portion of the reaction stream is withdrawn via the line 6a resulting from the dissolution of the aggregates in the solubilizer and containing only particles, the size of which is less than 1 mm, residues of the dissolution stage. A portion of the withdrawn reaction stream is recycled in the dissolution reactor according to the invention 200 via the line 5a and the other portion of the withdrawn reaction stream is discharged from the dissolution reactor via the line 7a to be directed to a conversion reactor 300 operating at a temperature of between 350° C. and 420° C., preferably between 380° C. and 400° C., in order to promote the thermal cracking reactions of the hydrocarbons making possible their conversion without, however, producing an excessive amount of very light gas fractions. The pressure in this reactor is controlled in order to keep a majority of the hydrocarbons in the liquid form, typically more than 50% by weight of the incoming feedstock, preferably more than 80% by weight of the incoming feedstock, in the reactor 300. The gaseous effluent 8 obtained is subsequently cooled in a condensation and separation zone 400 in order to obtain a liquid effluent 18 and an effluent of noncondensable fractions 17. The liquid fraction 9 exiting the reactor 300 contains the carbon black initially contained in the aggregates of the initial solid feedstock, which, under the effect of the dissolution and of the thermal cracking reactions, is found to be completely released. The carbon black consists essentially of very fine individual or agglomerated particles of micron or submicron scale, the size of which does not exceed 50-100 μm. The liquid fraction 9 is sent to a filtration zone 500 which makes it possible to separate these particles and to produce a particle-free filtrate 10 and a cake still impregnated with hydrocarbon compounds 21 which is subsequently sent into a washing zone 700 in the presence of a light external solvent 22, 23, such as acetone, toluene or xylene. The solvent and the hydrocarbon compounds are separated in a separation zone 800, for example by distillation. After the separation stage, the solvent can be recycled upstream of the washing zone via the line 24 and the recovered hydrocarbon compounds can be sent, together with the filtrate, via the line 11 into a distillation zone 600 to produce hydrocarbon cuts 12, 14 comprising boiling points set by the operator. The solvent used in the solubilization reactor according to the invention 200 can be composed of a portion of the liquid fractions 20 exiting at the top of the reactor 300 or of a portion of the liquid fractions recovered at the bottom of the reactor 300 after filtration 500, i.e. the fractions 13 and 16. The remaining fractions 19, 27, and 15 can be upgraded in other external processes.

### EXAMPLES

The aim of the examples which follow is to show the advantage of a reactor according to the invention by comparing the dimensioning of such a reactor with an installation using two perfectly stirred reactors operating sequentially in closed mode (batch mode).

### Example 1: Reactor in Accordance with the Invention

A dissolution reactor which makes it possible to treat used tyre aggregates with a capacity of 15 kt per year is considered. The aggregates have a size of between 10 and 15 mm. The reactor according to the invention is that as described in FIG. 3.

The dissolution reactor in accordance with the invention exhibits the following structural characteristics:
diameter of the lower part 220=1.44 m
height of the lower part 220=5.76 m
diameter of the upper part 210=2.88 m
height of liquid in the upper part 210=3 m
height of the deflector 230=1.98 m.

The total volume of the dissolution reaction zone occupied by the reaction stream is 36.4 m³.

For a degree of solvent of 2.5 (defined as the ratio of the solvent flow rate to the tyre aggregate flow rate), the incoming tyre flow rate is 1.875 t/h (8000 h/year) and the solvent flow rate is 4.688 t/h. The flow rate of recycled reaction stream supplied to the base of the lower part is approximately 200 t/h by virtue of the recirculation of a portion of the dissolved products. Under these conditions, the withdrawn reaction stream is composed of a liquid phase, the viscosity of which at 100° C. is approximately 13 cSt and the concentration of particles of which (carbon black and tyre aggregates which are partially dissolved, the size of which is less than 1 mm) is of the order of 10% by volume.

For a higher degree of solvent of 5.5 (ratio of the solvent flow rate to the tyre aggregate flow rate), the incoming tyre flow rate is 1.875 t/h (8000 h/year) and the flow rate of solvent is 9.375 t/h. The flow rate of recycled reaction stream supplied to the base of the lower part is approximately 200 t/h by virtue of the recirculation of a portion of the dissolved products. Under these conditions, the withdrawn reaction stream is composed of a liquid phase, the viscosity of which at 100° C. is approximately 9 cSt and the concentration of particles of which (carbon black and tyre granulates which are partially dissolved, the size of which is less than 1 mm) is of the order of 5.8% by volume.

Thus, the dissolution reactor in accordance with the invention makes it possible to operate with very variable degrees of solvent and this makes it possible to adjust the quality of the withdrawn reaction stream comprising the products of interest (carbon black).

### Example 2: Installation not in Accordance with the Invention

The same example was carried out by dimensioning a unit making it possible to dissolve the same amount of used tyre aggregates in perfectly stirred reactors. Since the effluents from a perfectly stirred reactor have the properties of the contents in the perfectly stirred reactor, it is necessary for the aggregates contained in the perfectly stirred reactor to be exposed to a reaction time sufficient for them to be sufficiently dissolved. It is thus necessary to operate the perfectly stirred reactor in closed mode and, in order to ensure an equivalent continuous operation, to have available two reactors in parallel: the first reactor is in unloading/loading operation while the second reactor is in dissolution operation, and then vice versa.

For such an installation, the minimum cycle time to ensure wetting of the aggregates, the rise in temperature and the dissolution is at least 3 hours. Moreover, taking into account the swelling of the aggregates and the interstitial space between the aggregates, the minimum amount of solvent for immersing all the aggregates and making it possible for them to be mechanically stirred is at least 5 times the amount by volume of aggregates.

It is thus necessary to treat in each reactor 5.625 t of aggregates, i.e. a volume of 5.625 m³ for each reactor. The volume of solvent necessary is thus 28.1 m³ and the reaction zone comprises a minimum volume of 33.75 m³ in each reactor. Finally, with 2 reactors, the minimum total volume is 67.5 m³, i.e. approximately twice the volume of the reaction stream in the context of the dissolution reactor according to the invention. Under these conditions, the withdrawn reaction stream is composed of a liquid, the viscosity of which at 100° C. is approximately 9 cSt and the concentration of particles of which (carbon black and tyre aggregates which are partially dissolved, the size of which is less than 1 mm) is of the order of 5.8% by volume, which is identical to the properties of the reactor according to the invention operating with a degree of solvent of 5 weight/weight. However, the perfectly stirred reactor does not give the possibility of reducing the degree of solvent, unlike the reactor according to the invention. This is because, if the degree of solvent in the perfectly stirred reactor is decreased, a portion of the aggregates will no longer be in contact with the solvent, which will significantly reduce the performance qualities of the dissolution process.

1. A reactor for dissolution of a solid feedstock based on thermosetting materials existing in the form of aggregates with sizes of between a first minimum value and a second maximum value, such as used tire aggregates, in the presence of a reaction stream having an upward flow comprising a liquid solvent, said solvent being capable of dissolving said solid feedstock, said reactor comprising:
a chamber (1) of elongate shape along the vertical axis, said chamber (1) comprising an upper part (210) of cross-section S1 and a lower part (220) of cross-section S2, the upper part (210) being located above the lower part (220) along the vertical axis;
a means for introduction (2) of the solid feedstock located in the upper part (210) of the chamber (1);
a means for introduction (4) of the liquid solvent;
a means for discharge (7) of at least a fraction of the reaction stream outside said dissolution reactor;
a means for bleeding off (3) a gas fraction located at the top of the chamber (1) of the reactor;
said reactor being characterized in that:
the cross-section S1 of the upper part (210) of the chamber (1) is greater than the cross-section S2 of the lower part (220) of the chamber (1); and in that
said reactor additionally comprises a loop for recirculation of the reaction stream comprising a means for withdrawal (6) of at least a fraction of the reaction stream located at the level of the upper part (210) of the chamber (1) and a means for introduction (5) of at least a fraction of the withdrawn reaction stream located at the level of the lower part (220) of the chamber (1).

2. The reactor according to claim 1, wherein the upper part (210) and the lower part (220) have a substantially circular section, and in that the ratio of the diameter of the cross-section S2 to the diameter of the cross-section S1 is of between 0.1 and 0.8.

3. The reactor according to claim 1, wherein the upper part (210) of the chamber (1) and the lower part (220) of the chamber (1) are connected by a frustoconical element (260) opening out upwards along the vertical axis.

4. The reactor according to claim 3, wherein the half-angle formed by the cross-section of said frustoconical element (260) with the vertical axis is of between 7° and 45°.

5. The reactor according to claim 1, wherein the means for discharge (7) of at least a fraction of the reaction stream is located in the recirculation loop between said withdrawal means (6) and said introduction means (5).

6. The reactor according to claim 1, wherein said means for introduction (2) of the solid feedstock is located at the top of the chamber (1) of the reactor.

7. The reactor according to claim 6, wherein the means for withdrawal (6) of at least a fraction of the reaction stream is located axially at the center of the cross-section of the upper part (210) overhung by a deflector (230).

8. The reactor according to claim 1, wherein the means for introduction (2) of the solid feedstock is located at the periphery of the upper part (210) of the chamber (1) of the reactor.

9. The reactor according to claim 8, further comprising at least one grid (250) positioned along the vertical axis in the upper part (210) of the chamber (1) of the reactor, between the wall of the chamber (1) of the reactor and the means for withdrawal (6) of the reaction stream, and in that the bottom part of said grid (250) is located at a lower height than the inlet of the withdrawal means (6).

10. The reactor according to claim 1, wherein the means for introduction (4) of the liquid solvent is located either in the lower part (220) of the chamber (1) or directly in the loop for recirculation of the reaction stream.

11. A continuous process for dissolution of a solid feedstock based on thermosetting materials existing in the form of aggregates with sizes of between a first minimum value and a second maximum value in the presence of a reaction stream containing a circulating liquid solvent having an upward flow in a reactor according to any one of claim 1, operating at a temperature of between 150° C. and 350° C., said process comprising:
introducing the liquid solvent into the chamber (1) of the reactor so as to completely immerse the lower part (220) of said chamber (1) and to partially immerse the upper part (210) of said chamber (1), forming a gaseous headspace above the reaction stream;
introducing the solid feedstock into the upper part (210) of the chamber (1) of the reactor;
withdrawing a fraction of the reaction stream located in the upper part (210) of the chamber (1);
discharging at least a portion of the withdrawn reaction stream outside said process; and
recycling at least a portion of the withdrawn reaction stream into the lower part (220) of the chamber (1);
wherein the superficial velocity of the reaction stream in the upper part (210) is fixed at a value lower than the terminal fall velocity calculated for aggregates having a size equal to the first minimum value and the superficial velocity of the reaction stream in the lower part (220) is fixed at a value greater than the minimum fluidization velocity calculated for aggregates having a size equal to the first minimum value, and wherein the superficial velocities in the upper part and the lower part are different.

12. The process according to claim 11, in which the minimum value is equal to 1 mm and the maximum value is equal to 25 mm.

13. The process according to claim 11, in which the superficial velocity of the reaction stream in the upper part (210) is less than 1 cm/s.

14. The process according to claim 11, in which the superficial velocity of the reaction stream in the lower part (220) is of between 2 and 15 cm/s.

15. The process according to claim 11, in which the residence time of the solid feedstock in the lower part (220) of the chamber of the reactor is of between 15 minutes and 20 hours.

16. The process according claim 11, in which the solid feedstock is introduced into the gaseous headspace located in the upper part (210) of the chamber (1).

17. The process according to claim 11, in which the ratio by weight of the liquid solvent to the solid feedstock is less than 2.5 weight/weight.

18. The process according to claim 11, wherein the solid feedstock is a feedstock based on used tire aggregates.
